(19) United States
(12) Patent Application Publication
(10) Pub. No.: US 2004/0036362 A1
(43) Pub. Date: Feb. 26, 2004

(54) Meter power transfer switch

(75) Inventors: James W. Beck, Minneapolis, MN (US); Gary A. Hoonsbeen, Minneapolis, MN (US); Robert J. Marks, New Hope, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Power Quality, LLC, Eden Prairie, MN

(21) Appl. No.: 10/223,985

(22) Filed: Aug. 20, 2002

(51) Int. Cl. H02H 1/00

(52) U.S. Cl. 307/125

(57) ABSTRACT

A power transfer switch is used between a watt-hour meter and a meter box. The meter box has main power contacts which are connected to a main power source and customer-side contacts which are connected to at least one load. The power transfer switch includes a base with first contacts for connection to the main power contacts of the meter box and second contacts for connection to the customer-side contacts of the meter box. The base has further contacts for connection with the watt-hour meter and contacts for connection with a standby power source. The power transfer switch also includes a rotary switch. The rotary switch has a first position in which the main power contacts are connected to the customer-side contacts and a second position in which the standby power source is connected to the customer-side contacts.

### CROSS-REFERENCE TO RELATED APPLICATION(S)

None.

### BACKGROUND OF THE INVENTION

The present invention relates to a power transfer switch for manually and automatically switching an electrical load between a main power source and a standby power source.

Occupants of a house, building or other facility are concerned about the consequences of a power failure, whether or not the power failure is expected, and the ability to use power which they generate or store on-site. Oftentimes, a standby power source, such as a motor generator, is connected to the wiring of the facility to provide power when use of the main power source has failed or is not desired. A large transfer switch is installed at the main electrical circuit box to monitor the incoming power from the main power source. The main power source is typically a power grid system in the locality, or a utility. When the main power fails, the transfer switch disconnects the electricity from the main power source, starts the engine of a motor generator installed near the facility, and transfers the facility's electrical load to the standby power source. When the main power source is restored to full power, the transfer switch transfers the facility's electrical load back to the main power source and terminates operation of the motor generator. The transfer switch may be automatically or manually activated.

Building occupants who want the option of switching between a main power source and a standby power source must modify the wiring of their electrical distribution system to accommodate the standby power source. Such modification requires rewiring the facility, and is time-consuming and expensive. In a power standby system, utilizing an automatic transfer switch described above, installation is best performed when the facility is under construction. At that time, electricians can run the necessary conduit and electrical wires to the transfer switch and from the transfer switch to the standby motor generator. When installing the transfer switch in existing facilities, the complications caused by the need to re-wire the electrical power panels and install a standby generator are expensive and time-consuming.

In such applications, especially existing facilities where re-wiring the main electrical circuit box is prohibitive, an alternate means for transferring the electrical load to a standby power source is desired. A power transfer switch is desired that is easier and less expensive to install, has a smaller, efficient package and does not require any electrical wiring changes to existing electrical power panels. Furthermore, a power transfer switch is desired that is fail-safe and cannot be cross-connected by electrical malfunction.

### BRIEF SUMMARY OF THE INVENTION

The present invention relates to a power transfer switch for use between a watt-hour meter and a meter box. The meter box has main power contacts which are connected to a main power source and customer-side contacts which are connected to at least one load. The power transfer switch includes a base with first contacts for connection to the main power contacts of the meter box and second contacts for connection to the customer-side contacts of the meter box. The base has further contacts for connection with the watt-hour meter and contacts for connection with a standby power source. The power transfer switch also includes a rotary switch. The rotary switch has a first position in which the main power contacts are connected to the customer-side contacts and a second position in which the standby power source is connected to the customer-side contacts.

### BRIEF DESCRIPTION OF THE DRAWINGS

FIG. 1 is an exploded perspective view of a meter collar and associated components.

FIG. 2A is a front perspective view of a switch assembly.

FIG. 2B is a rear perspective view of the switch assembly.

FIG. 3 is an exploded view of the switch assembly housing an automatic power transfer switch.

FIG. 4 is an exploded view of a meter housing.

FIG. 5A is a front perspective view of a switch plate and a fuse plate.

FIG. 5B is a front perspective view of the switch plate with a cover plate removed.

FIG. 6 is a front view of the power transfer switch.

FIG. 7A is a rear perspective view of the fuse plate.

FIG. 7B is an exploded view of the fuse plate.

FIG. 8 is a rear perspective view of the switch plate.

FIG. 9 is an exploded view of the switch plate.

FIG. 10 is a schematic diagram of an automatic power transfer switch.

FIG. 11 is an exploded perspective view of a meter collar and associated components.

FIG. 12 is an exploded view of the switch assembly housing a manual power transfer switch.

FIG. 13 is a schematic diagram of the manual power transfer switch.

### DETAILED DESCRIPTION

Introduction

The present invention is a power transfer switch for switching an electrical load of a facility between a main power source, such as a utility, and a standby power source, such as a generator. The present invention power transfer switch may be used to retrofit an electric meter in an existing building or used as an original installation for a new building. A power transfer switch used to retrofit an existing building is housed in a meter collar, which is connected between a watt-hour meter and a meter box of an electric meter. A power transfer switch for use with a new building is housed in a self-contained unit including a switch assembly and the meter.

In addition, the present invention power transfer switch is either an automatically actuated switch or a manually actuated switch. One embodiment of an automatically actuated switch includes a power transfer switch and a control box, or interface circuit. The control box includes a control mechanism for activating an automatic actuator to actuate the power transfer switch. This embodiment would be housed in a meter collar and used to retrofit an existing building by connecting the meter collar between a watt-hour meter and a meter box. Another embodiment of the automatically actuated switch includes in a single, self-contained unit a power transfer switch, a control box, and a meter. This embodiment would be used in a new building as an original installation electric meter. An embodiment of the present invention for a manually actuated switch includes a power transfer switch, which can be housed in a meter collar for use with an existing building or in a self-contained unit including a meter for use in a new building. Finally, either the automatic or manual power transfer switch may be housed in a meter collar or separate switch assembly for use in a new building in conjunction with a separately provided meter.

The discussion below of the automatic power transfer switch and the manual power transfer switch is specifically done with respect to a version housed in a meter collar or switch assembly for use with an existing building. However, embodiments of the switches housed in a self-contained unit including the switch and meter are also envisioned by the present invention.

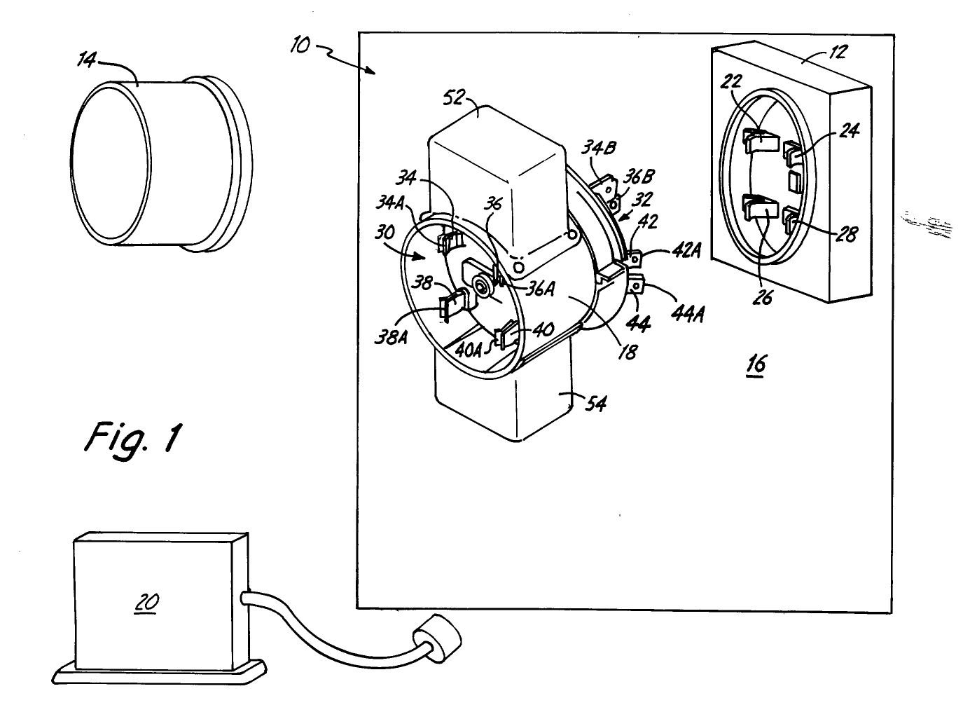

Automatic Power Transfer Switch (FIGS. 1-11)

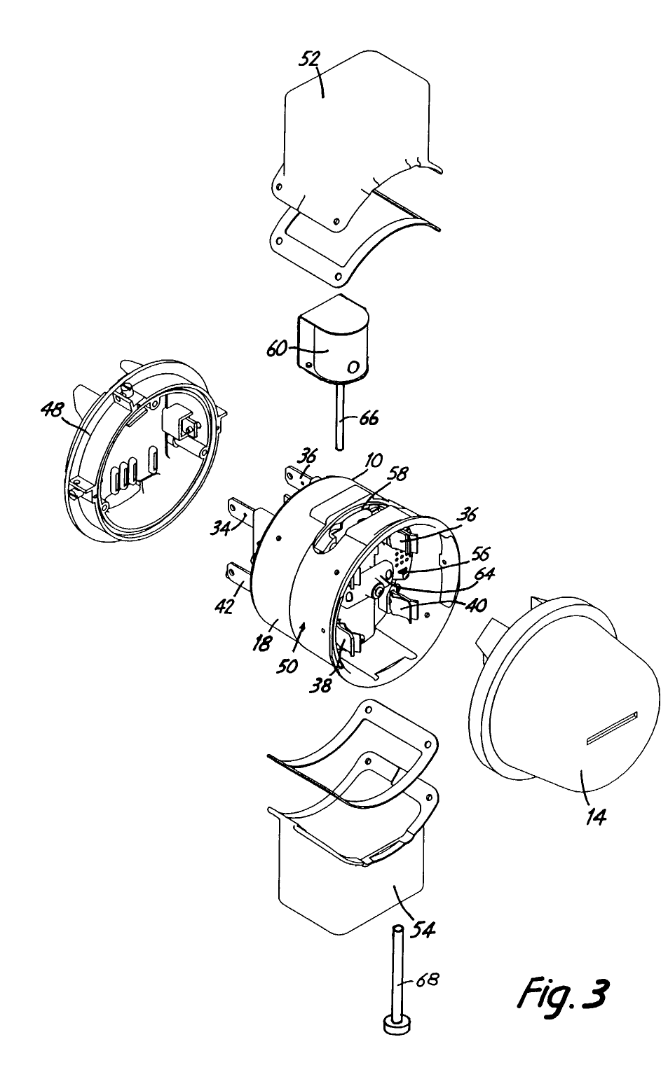

FIG. 1 is an exploded perspective view of a meter collar 10 that fits between and is connected to a meter box 12 and a watt-hour meter 14. Meter box 12 and watt-hour meter 14 comprise an electric meter which is typically installed on the outside of a facility 16, such as a home, office or other building. The meter is installed at the time facility 16 is first occupied and is used to record and monitor power consumption by the user. Meter collar 10 forms a meter extension and is fitted between meter box 12 and watt-hour meter 14. Meter collar 10 houses a power transfer switch (shown in FIG. 3) in a switch housing 18. The power transfer switch automatically transfers an electrical load of facility 16 between a main power source (not shown) and a standby power source 20 when main power is lost or restored.

Meter box 12 includes main power contacts 22 and 24 and load contacts 26 and 28, or customer side contacts. Main power contacts 22 and 24 are connected to the main power source, such as a power grid system or power lines of a utility. Load contacts 26 and 28 are connected to the electrical load of facility 16. Standby power source 20 is connected to the power transfer switch self-contained in switch housing 18. Standby power source 20 is preferably a motor generator.

Meter collar 10 fits between meter box 12 and watt-hour meter 14, and plugs directly into the two. Meter collar 10 has a meter end 30 and a box end 32. Meter collar 10 includes a pair of main power bus bars 34 and 36, each having a female end 34A and 36A at meter end 30 and a male end 34B and 36B at box end 32. Female ends 34A and 36A of main power bus bars 34 and 36 are attached to input connections (not shown) in watt-hour meter 14. Male ends 34B and 36B of main power bus bars 34 and 36 are attached to main power contacts 22 and 24 in the meter box 12.

Also connected to the power transfer switch is a pair of meter bus bars 38 and 40, or meter contacts, having female ends 38A, 40A at meter end 30 and a pair load bus bars 42 and 44 having male ends 42A and 44A at box end 32. Female ends 38A and 40A of meter bus bars 38 and 40 are attached to output connections (not shown) in watt-hour meter 14. Male ends 42A and 44A of load bus bars 42 and 44 are terminated at and attached to load contacts 26 and 28 in meter box 12. These attachments connect meter collar 10 to watt-hour meter 14 and meter box 12.

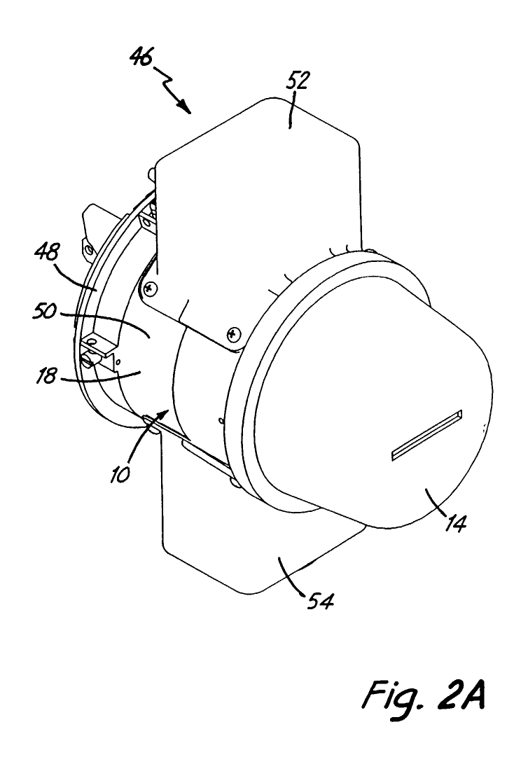

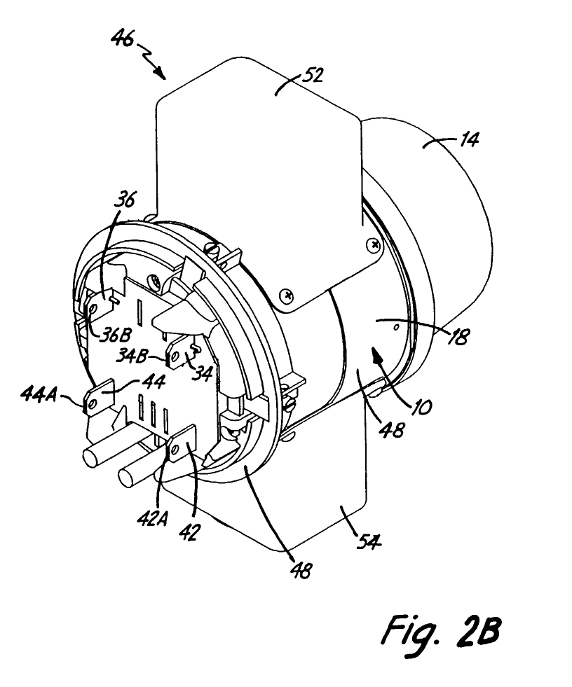

FIG. 2A is a front perspective view of switch assembly 46 and FIG. 2B is a rear perspective view of switch assembly 46. Switch assembly 46 includes watt-hour meter 14 and meter collar 10. Meter collar 10 is comprised of switch housing 18 (or meter housing), which houses the power transfer switch (not shown), and a meter base 48. Switch housing 18 includes a sidewall 50, and a first housing 52 and a second housing 54 attached to sidewall 50.

FIG. 3 is an exploded view of an embodiment of switch assembly 46 housing an automatically actuated power transfer switch. Switch assembly 46 includes watt-hour meter 14 and meter collar 10 comprised of switch housing 18 and meter base 48. Switch housing 18 houses a power transfer switch 56. Switch housing 18 is preferably round and plastic. Port 58 are formed in sidewall 50 of switch housing 18 to allow connections to be made between the power transfer switch 56 and components housed outside switch housing 18, such as an automatic actuator. Although not shown in FIG. 3, in an automatically actuated transfer switch 56, wires from standby power source 20 are connected to the transfer switch.

Watt-hour meter 14 is attached to meter collar 10 by main power bus bars 34, 36 and meter bus bars 38, 40 connected to input and output connections within watt-hour meter 14. Main power bus bars 34, 36 and load bus bars 42, 44 extend from within meter housing 18 and through meter base 48 and are connected to main power contacts 22, 24 and load contacts 26, 28 in meter box 12 to attach meter collar 10 to the meter box (not shown). Main power bus bars 34 and 36 connect the main power source via main power contacts 22 and 24 to input connections of watt-hour meter 14. Meter bus bars 38 and 40 connect power transfer switch 56 to output connections of watt-hour meter 14 and load bus bars 42, 44 connect the power transfer switch attached to meter collar 10 by connecting input connections of watt-hour meter 14 to meter bus bars 38, 40 of meter collar 10. Meter base 48 is attached to box end 32 of switch housing 18.

In the embodiment shown in FIG. 3, an automatic actuator 60 is used to switch power transfer switch 56 between the main power source and standby power source 20. Automatic actuator 60 shown in FIG. 3 is a motor which is connected to power transfer switch 56, however, other devices may be used to actuate the power transfer switch, such as a pair of solenoids, a linear actuator or single double-acting solenoids. Actuator 60 is connected to an actuation disc 64 by connection bar 66 to permit automatic actuation of the switch 56. In response to a signal to transfer power to standby power source 20, actuator 60 pulls disc 64 through connection bar 66 and thereby rotates power transfer switch 56. In response to a signal to transfer power to the main power source, actuator 60 pushes disc 64 through connection bar 66 and thereby rotates power transfer switch 56. For protection purposes, actuator 60 is encased in housing 52.

In an automatically actuated switch, the main power source, or utility, is monitored. When a loss of the main power source is sensed, a signal is sent to standby power source 20 (FIG. 1), or generator, to start it. Once standby power source 20 is running, a signal is sent to actuator 60 to switch from the main power source to standby power source 20. When the main power source comes back on the reverse happens: and a signal is sent to actuator 60 to switch over to the main power source and a signal is sent to standby power source 20 to shut off. Actuator (or Motor) 60, housed within housing 52 attached to sidewall 50 of housing 18, are preferably used to actuate the power transfer switch and switch the power load between the main power source and standby power source 20. Housing 52 is attached to switch housing 18 and protects actuator 60 from contamination and destruction. Actuator 60 moves the rotary switch, and hence the load contacts 26, 28 connection between main power contacts 22, 24 and standby power source 20. Futhermore, a manual override switch 68 may be included to allow activation by an operator of power transfer switch 56 from one power source to another. Override switch is connected to an opposite end of actuation disc 64 from connection bar 66. Movement of override switch 68 up or down, i.e. push/pull movement, pushes or pulls actuation disc 64 to rotate power transfer switch 56. Activation of actuator 60 requires power, which is provided by the power source the facility electrical load is being transferred to. No transfer of the facility's electrical load is necessary unless a power source is on and ready to provide power. Additionally, a crank battery for standby power source 20 is available to power actuator 60 until either power source is available.

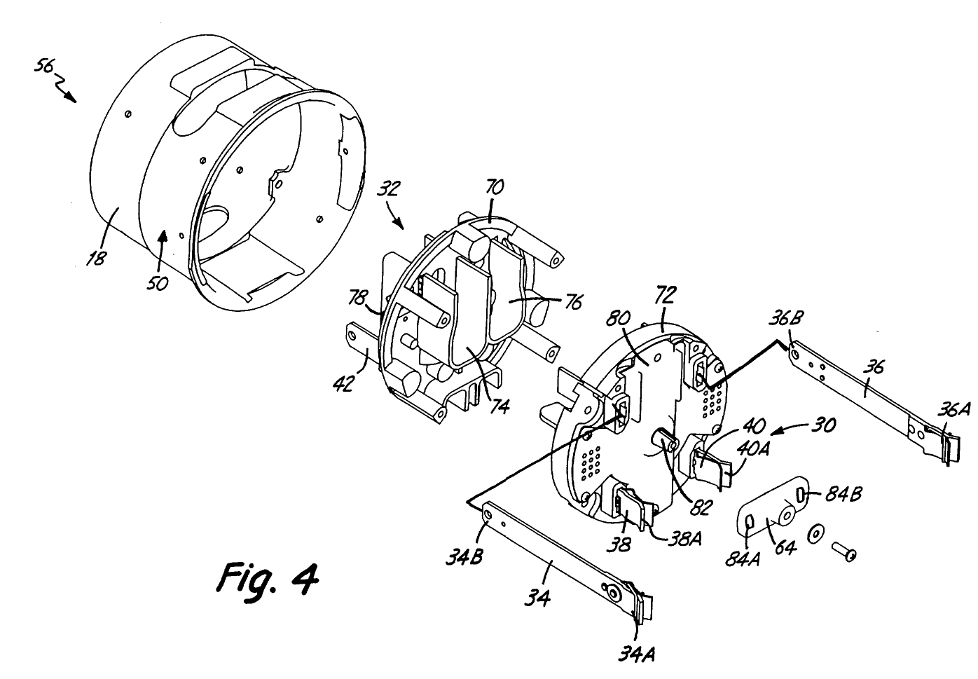

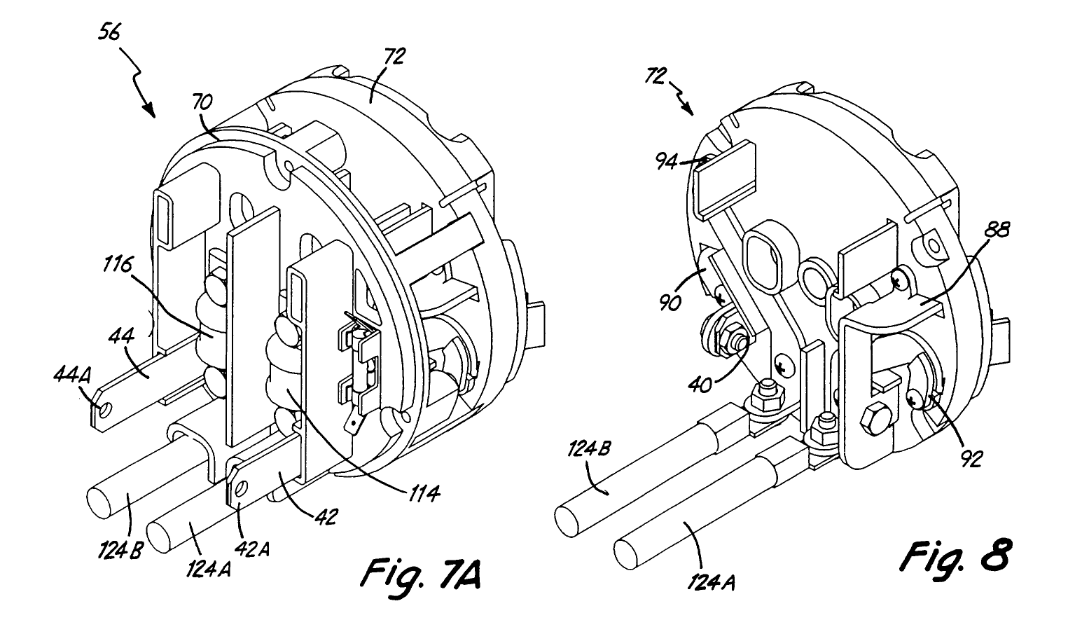

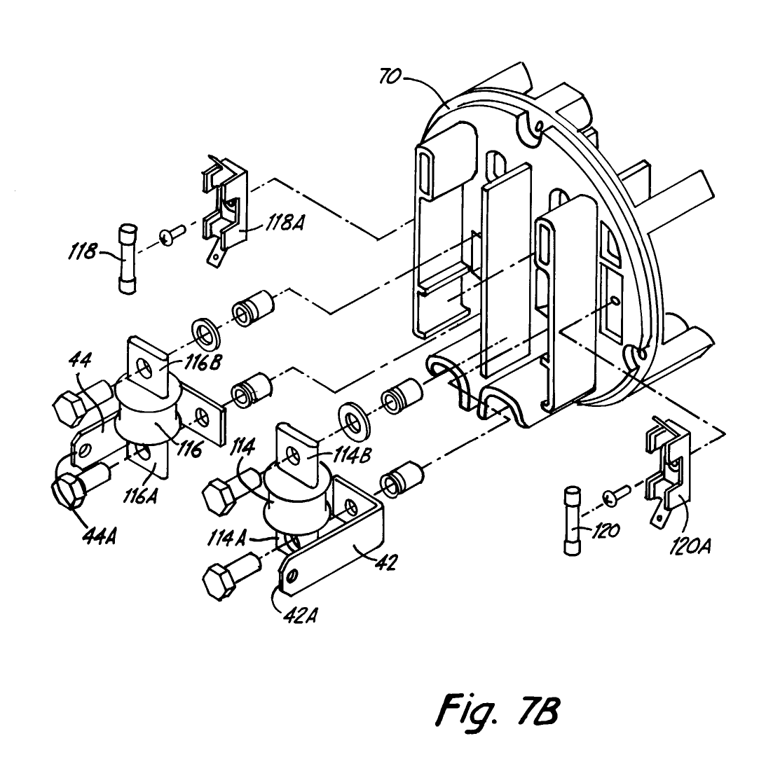

FIG. 4 is an exploded view of an automatically actuated power transfer switch 56 housed within meter housing 18. Power transfer switch 56 includes a fuse plate 70 and a switch plate 72, or base (or stator), stacked within switch housing 18. The components are preferably assembled in a self-contained stack within switch housing 18. Fuses (shown in FIG. 7) housed within fuse receptacles 74 and 76, are attached to a lower side 78 of the fuse plate 70. Fuse receptacles 74 and 76 protect the fuses.

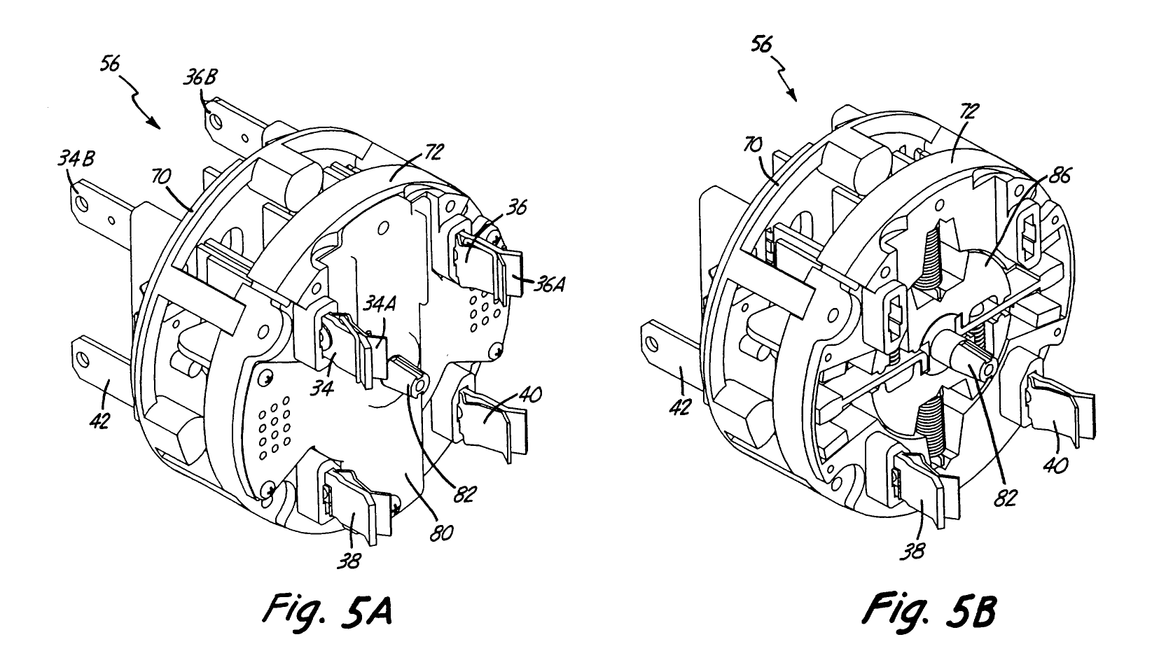

Switch plate 72, or stator, supports a rotor (shown in FIG. 5B). Cover plate 80 covers the rotor (not shown) and is attached to the switch plate 72 to protect the rotor. Cover plate 80 is preferably held in place with self-threading screws.

Actuation disc 64 is attached to a rotor shaft 82 that passes through cover plate 80 and is preferably located adjacent the front of cover plate 80. Actuator 60 used to actuate switch 56 is attached to disc 64. Connection bar 66 and override switch 68 (not shown) are attached to mounting holes 84A and 84B in disc 64. When either actuator 60 or switch 68 is activated, the respective connection bar or switch is pulled, which thereby rotates disc 64 and power transfer switch 56 (via the rotor shaft 82).

Main power bus bars 34 and 36 pass through transfer switch 56 and are supported in switch plate 72 at meter end 30 of meter collar 10 and in fuse plate 70 at box end 32. Female ends 34A and 36A of main power bus bars 34 and 36 terminate directly to input connections of watt-hour meter 14 (not shown). Male ends 34B and 36B of main power bus bars 34 and 36 terminate at the power side, main power contacts 22 and 24 in meter box 12 (not shown). There is no electrical connection between main power bus bars 34, 36 and transfer switch 56. Main power bus bars 34, 36 are held in position by switch plate 72 and fuse plate 70. Switch plate 72 and fuse plate 70 prevent main power bus bars 34, 36 from pushing through either plate. Alternatively, hardware, such as rivets, pins or bolts, may be used to hold main bus bars 34, 36 in position and to keep them from pushing through either plate.

Meter bus bars 38 and 40 pass through and are supported by switch plate 72. Female ends 38A and 40A of meter bus bars 38, 40 terminate directly to output connections in watt-hour meter 14. Meter bus bars 38, 40 are held in position by switch plate 72. Switch plate 72 prevents meter bars 38 and 40 from being pushed or lifted through switch plate 72. Alternatively, hardware, such as rivets, bolts or pins may be used to hold the meter bus bars 38, 40 in position.

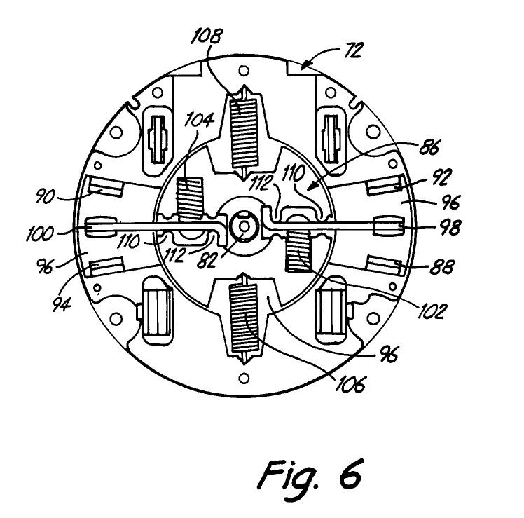

FIG. 5A is front perspective view of an automatic or manually actuated power transfer switch 56 and FIG. 5B is a front perspective view of power transfer switch 56 with cover plate 80 removed to reveal a rotor 86, or rotary switch. Power transfer switch 56 is comprised of fuse plate 70 and switch plate 72. Cover plate 80 covers rotor 86 supported by switch plate 72 or the stator. Removal of cover plate 80 allows access to rotary switch 86 supported by the stator, which can be seen in FIG. 6, a front view of rotor 86 and switch plate 72, or stator, of power transfer switch 56.

Switch plate 72 supports main power stationary contact blocks 88 and 90 and standby power stationary contact blocks 92 and 94. Stationary contact blocks 88-94 are placed around the circumference of stator 72 such that the contact blocks are arranged in alternating patern between a main power contact block and a standby power contact block. The contact blocks 88-94 are supported and/or attached to the switch plate 72 in many different ways, including being received by receptacles formed in the switch plate 72 or by attaching the contact blocks 88-94 to the switch plate 72 using rivets, pins, screws, bolts, nuts and locking washers or other types of hardware.

Rotor 86 is housed within a cavity 96 formed in switch plate 72. Rotor 86 includes rotor shaft 82. Rotor contact bars 98 and 100 are supported by rotor 86 and held in position within portions of cavity 96 of switch plate 72 by coil springs 102 and 104. Each rotor contact bar is held in position within cavity 96 with tension produced by coil contact springs 102, 104 held against the contact bar. A screw is used to hold contact springs 102, 104 at the proper pressure point on the rotor contact bar. A pair of coil rotor springs 106, 108 are biased between rotor 86 and stator 72. Portions of cavity 96 are located between each pair of main power contact blocks 88, 90 and standby power contact blocks 92, 94 to house rotor contact bars 98, 100 and allow movement of rotor contact bars 98, 100 between stationary contact blocks 88-94. Each rotor contact bar is positioned between one main power contact block and one standby power contact block.

Rotor contact bars 98, 100 rotate between a first position and a second position. In the first position, rotor contact bars 98, 100 engage main power contact blocks 88, 90 and the main power source provides power to the electrical load in facility 16 (not shown). Actuating the actuator rotates rotor 86 holding rotor contact bars 98, 100 to the second position. Actuation of the actuator includes rotating shaft 82 of rotor 86, which thereby pivots the contact bars between contact blocks 88-94. As rotor 86 turns, the contact pressure (electrical connection) between main power contact blocks 88, 90 and rotor contact bars 98, 100, created by contact springs 102, 104, is broken. Rotor contact bars 98, 100 pivot off embossment 110 and the connection between the electrical load and the main power source is broken.

As rotor 86 continues to be rotated by actuator 60 (FIG. 3), rotor 86 reaches a point where rotor springs 106, 108 are fully compressed. Beyond this point, about 10° of rotation, the pressure of rotor springs 106, 108 force rotor 86 to be “self energized”. The force of rotor springs 106, 108 continues rotor 86 through the rotation.

As rotor 86 is forced into a fully counterclockwise rotation by rotor springs 106, 108, at the second position rotor contact bars 98, 100 engage standby power contact blocks 92, 94 with the combined pressure from rotor springs 106, 108 and contact springs 102, 104. Rotor contact bars 98, 100 now pivot off rotor embossment 112. This action results in an electrical connection between rotor contact bars 98, 100 and standby power contact blocks 92, 94. This connection provides a path for the electrical power, supplied by standby power source 20 (shown in FIG. 1) to the facility's electrical load.

FIG. 7A is a rear perspective view of power transfer switch 56, in particular fuse plate 70, and FIG. 7B is an exploded view of fuse plate 70. Power transfer switch 56 also includes fuses 114 and 116 which are supported by fuse plate 70. Each fuse includes a first fuse terminal 114A, 116A and a second fuse terminal 114B, 116B. The first and second fuse terminals are located at either end of fuses 114 and 116. In alternate embodiments, the fuse terminals may be connected to the ends of the fuses by hardware, such as brass bolts, nuts and locking washers or the fuses could be replaced by bus bars. Fuses 114 and 116 are accessible by detaching meter collar 10 from the meter box 12 (not shown). Fuses 114, 116 are connected between rotor contact bars 98, 100 and load bus bars 42, 44, preferably by heavy, flexible electrical cable (shown in FIG. 10). Fuses 114 and 116 are connected to the fuse plate 70 and housed within fuse receptacles 74, 76. Fuse receptacles 74, 76 (shown in FIG. 4) extend outward from a front face of fuse plate 70 and fuses 114, 116 are connected at a back face of fuse plate 70. Sense fuses 118 and 120 are housed within fuse receptacles 118A and 120A, which are attached to fuse plate 70.

Load bus bars 42 and 44 are supported by fuse plate 70. Load bus bars 42 and 44 are held in position at top ends 42B and 44B by hardware to prevent the load bus bars 42, 44 from pushing through fuse plate 70. Fuse plate 70 also prevents load bus bars 42, 44 from being forced through fuse plate 70. Alternatively, hardware, such as rivets, brass bolts, nuts and washers, may be used to hold load bus bars 42, 44 in and to prevent them from pushing fuse plate 70. Male ends 42A, 44A of load bus bars 42 and 44 terminate in meter box 12 at load contacts 26 and 28 of the electrical load (shown in FIG. 1). In addition, the male ends of the main power bus bars 34, 36 also pass through and are supported by the fuse plate 70. Preferably, fuses 114 and 116 are connected to load bus bars 42 and 44 at fuse terminals 114A, 116A. Although, fuses 114, 116 are shown as directly connected to load bus bars 42, 44 by hardware, other methods of connection may be utilized, such as heavy, flexible cable.

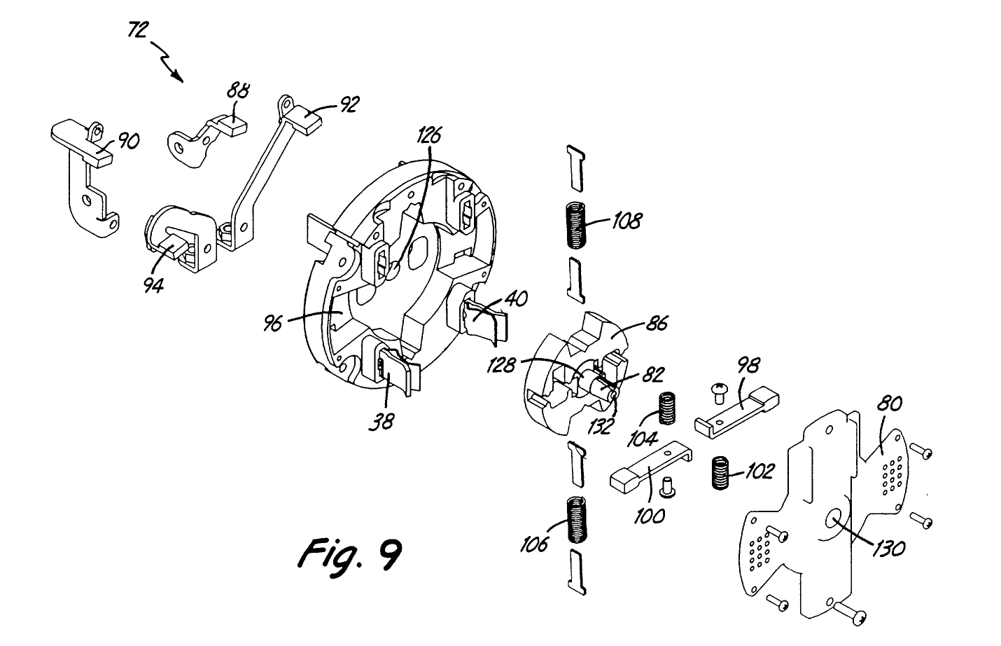

FIG. 8 is a rear perspective view of switch plate 72 or switch plate. Bottom ends, or male ends 38B and 40B of meter bus bars 38 and 40 are supported by switch plate 72. On the back side of switch plate 72, male ends 38B and 40B of meter bus bars 38, 40 are connected to main power contact blocks 88 and 90 (mounted in switch plate 72). Also on the back side of switch plate 72, standby power contact blocks 92 and 94 mounted in switch plate 72 are connected to heavy, flexible electrical cables 124A, 124B. Cable 124A, 124B is routed to the outside of switch housing 18 and terminates at the standby power receptacle (shown in FIG. 3) or directly at standby power source 20.

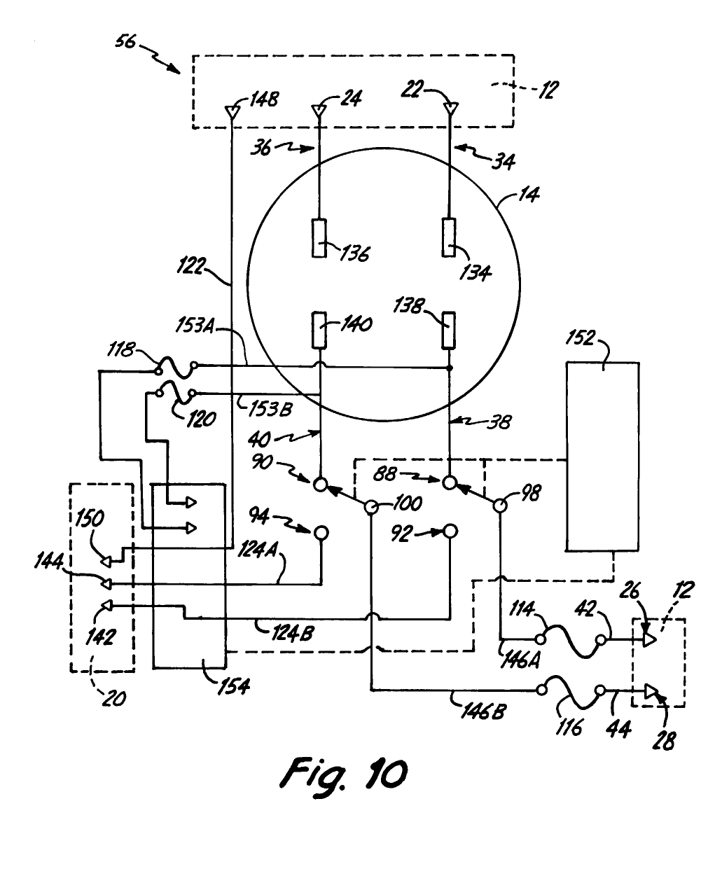

FIG. 9 is an exploded view of switch plate 72 and rotary switch 86. Switch plate 72 supports cover plate 80, pair of rotor contact bars 98 and 100, rotor 86 including shaft 82, meter bus bars 38 and 40, main power bus bars (not shown), pair of main power stationary contact blocks 88 and 90, and pair of standby power stationary contact blocks 92 and 94. Meter bus bars 38 and 40 pass through and are supported by switch plate 72. Meter bus bars 38 and 40 are held in position vertically by switch plate 72 which prevents the meter bus bars from being pushed downward through switch plate 72 or from being pushed or lifted upwards through switch plate 72. The bottom end of meter bus bars 38 and 40 are connected to main power contact blocks 88, 90.

Main power stationary contact block 88 and 90 and standby power stationary contact blocks 92 and 94 are also supported by switch plate 72. Switch plate 72 includes cavity 96 for accommodating rotor 86, main power contact blocks 88, 90, stationary contact blocks 92, 94, and rotor contact bars 98, 100. Within cavity 96, main power and standby power contact blocks 88-94 alternate sequentially around the circumference of switch plate 72. Main power stationary contact blocks 88, 90 and standby power stationary contact blocks 92, 94 are preferably attached and held in position in switch plate 72 by rivets, pins, screws or brass bolts.

Rotor 86 is housed within cavity 96 of switch plate 72. Rotor 86 includes shaft 82. Switch plate 72 includes a support bearing 126 for a lower end 128 of shaft 82 of rotor 86. A support bearing 130 for upper end 132 of shaft 82 of rotor 86 is formed as part of cover plate 80. Rotor contact bars 98 and 100 are supported by rotor 86 and held in position within portions of cavity 96 of switch plate 72 by coil springs 102 and 104. Coil springs 102, 104 are positioned within cavity 96 between rotor 86 and rotor contact bars 98, 100. Preferably, coil springs 102, 104 are located or guided in position by screws, rivets or bolts attached to rotor contact bars 98, 100. Each rotor contact bar is positioned between one main power contact block and one standby power contact block. Rotor 86 is captured within switch plate 72 by cover plate 80. Cover plate 80 is preferably held in place with self threading screws.

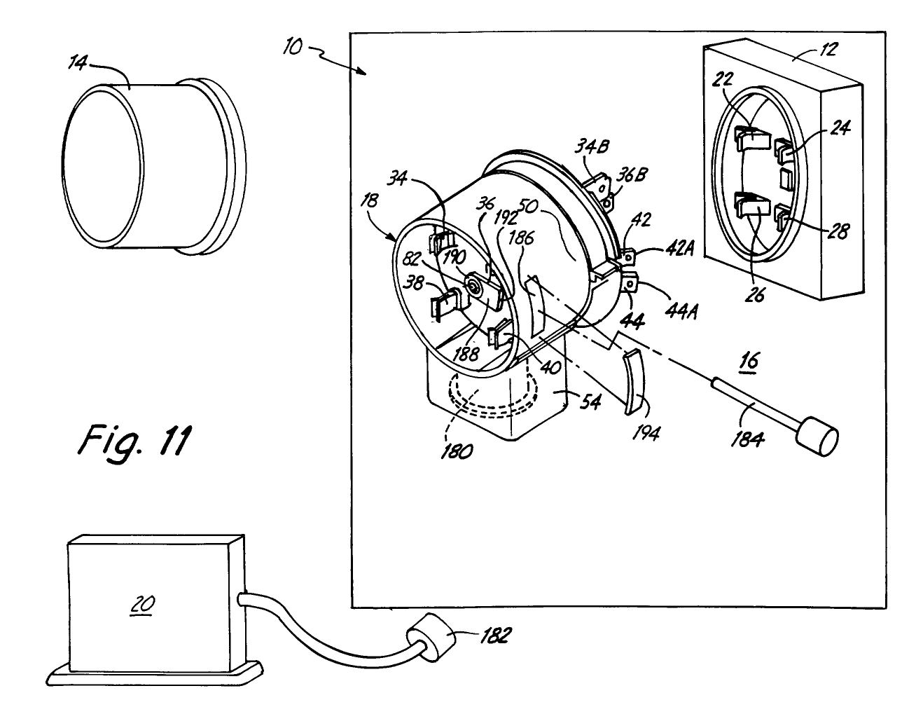

In an automatically actuated embodiment of the present invention, power transfer switch 56 is activated by actuator 60 (shown as a motor is FIG. 3), which is connected to actuation disc 64 by connection bar 66. Activation of actuator 60 rotates rotor 86 (via the shaft 82), and thereby rotor contact bars 98, 100 between main power contacts 88, 90 and standby power contacts 92, 94. Actuator 60 is activated automatically upon loss of power from the main source. A manually actuated embodiment of the present invention is discussed below with respect to FIG. 11.

FIG. 10 is a schematic diagram of power transfer switch 56 showing the electrical connections of transfer switch 56. Main power bus bars 34 and 36 connect the main power source to input connections 134 and 136 of watt-hour meter 14. Female ends 34A and 36A of main power bus bars 34 and 36 terminate at input connections 134 and 136 and male ends 34B and 36B terminate at main power contacts 22 and 24 in meter box 12. Meter bus bars 38 and 40 connect main power stationary contact blocks 88 and 90 with output connections 138 and 140 of watt-hour meter 14. Female ends 38A and 40A of meter bus bars 38 and 40 terminate at output connections 138 and 140, and connection bars connect meter bus bars 38, 40 to main power contact blocks 88, 90. Standby power stationary contact blocks 92 and 94 are connected by cable 124A, 124B to a pair of standby power conductors 142 and 144 connected to a standby power receptacle (discussed below) or directly to standby power source 20.

Rotor contact bars 98, 100 are connected to load contacts 26 and 28 in meter box 12, or customer-side contacts, via load bus bars 42, 44. Load bus bars 42 and 44 connect load contacts 26 and 28 of the electrical load to fuses 114 and 116 which are in turn connected to rotor contact bars 98 and 100. Male ends 42A and 44A of load bus bars 42, 44 terminate at load contacts 26 and 28. Load bus bars 42, 44 are connected to fuses 114 and 116. Cables 146A, 146B connect fuses 114, 116 to rotor contact bars 98, 100. Fuses 114 and 116 are connected between rotor contact bars 98 and 100 and load bus bars 42 and 44. First fuse terminals 114A and 116A are connected to load bus bars 42 and 44 and second fuse terminals 114B, 116B are connected to rotor contact bars 98, 100 by heavy, flexible electrical cables 146A, 146B. Cable 146A, 146B is preferably comprised of multi-strands of small wire to assure low restraint in high current carrying capacity. Alternatively, the fuses may be jumpered out and replaced with bus bars.

Neutral wire 122 connects watt-hour meter neutral bus bar 148 in meter box 12 to input connector 150 in standby power source 20, but does not terminate in housing 18. Neutral wire 122 passes through control box 154.

An automatic actuator 152 is connected to rotor 86, for example via shaft 82. One embodiment of automatic actuator 152 is motor 60 and actuation disc 64 shown in FIG. 3, however, further embodiments of the present invention may include other devices to automatically actuate the power transfer switch. Actuator 152 is connected to interface circuit 154, or control box. When interface circuit 154 senses a presence or absence of power to the main power source it sends a signal to actuator 152 to transfer power. Actuation of actuator 152 causes rotor 86 to rotate and thereby move rotor contact bars 98, 100 from main power contact blocks 88 and 90 to standby power contact blocks 92 and 94, or vice versa. In response to a signal to transfer power, motor 60 (shown in FIG. 3) is energized to pull actuation disc 64 (shown in FIG. 3) and thereby rotate rotor 86.

When the main power source is in use, power enters through main power contacts 22, 24 to the meter through main power bus bars 34, 36. The power then passes through meter bus bars 38, 40 from the meter. Meter bus bars 38, 40 transfer the power to the line side or the main power side of the switch at main power contact blocks 88, 90. When rotor contact bars 98 and 100 engage main power contact blocks 88 and 90, a connection is made between the main power source (through main power contacts 22 and 24) and the electrical load (through load contacts 26 and 28). Thus, the electrical load receives power from the main power source.

Wires 153A and 153B run directly from meter bus bars 38, 40, respectively to an interface circuit 154, or control box. The wires 153A, 153B are sense lines that sense what the available voltage from the main power source is, basically whether the main power source is on or not. Sense fuses 118 and 120 are connected between meter bus bars 38 and 40, respectively, and interface circuit 154 by wires 153A and 153B. Sense fuse wires 153A and 153B protect the sense lines and interface circuit 154 when there is a power surge. Interface circuit 154 then activates actuator 152 to actuate the power transfer switch and rotate rotor 86 between main power contact blocks 88, 90 and standby power contact blocks 92, 94.

When standby power source 20 is in use, power is transferred through cable 124A and 124B from power source 20 to the standby power side of the switch at standby power contact blocks 92, 94. When rotor contact bars 98 and 100 engage standby power contact blocks 92 and 94, a connection is made between standby power source 20 (through standby power conductors 142 and 144) and the electrical load (through load contacts 26 and 28). Thus, power to the electrical load is received from standby power source 20. Rotor contact bars 98, 100 can be switched back and forth between main power contact blocks 88, 90 and standby power contact blocks 92, 94 to supply the electrical load from either source depending on the wishes of the operator.

In an automatically actuated power transfer switch 56, interface circuit 154 (or control box) controls actuation of actuator 152 to provide power to the facility from either the main power source, typically a utility, or the standby power source. For example, in one situation the main power source is off and standby power source 20 is on. When the main power source is turned on, interface circuit 154 senses power to the main power source. Interface circuit 154 sends a signal to actuator 152 to rotate rotor 86 such that rotor contact bars 98, 100 engage main power contact blocks 88, 90. Thus, power to the facility is provided by the main power source. This function typically occurs after meter collar 10 and power transfer switch 56 has been installed.

In a second situation the main power source is on and providing power to the facility. A facility occupant starts standby power source 20. Interface circuit 154 senses power to the standby power source actuates actuator 152 such that power for the facility is provided by the standby power source. Rotor 86 rotates and rotor contact bars 98, 100 are disengaged from main power contact blocks 88, 90 and engage standby power contact blocks 92, 94. Once standby power source 20 is turned off by the facility occupant, interface circuit 154 senses removal of the generator power and actuates actuator 152. In the meantime, the main power source has been turned back on. Actuator 152 rotates rotor 86 such that rotor contact bars 98, 100 engage main power contact blocks 88, 90 such that the main power source provides power to the facility.

A final situation occurs when the facility is operating with power from the main power source, which then fails. Interface circuit 154 senses the loss of power from the main power source and starts standby power source 20. Interface circuit 154 then sends a signal to actuate actuator 152 which rotates rotor 86 and switches the power load from the main power source to the standby power source.

Other control circuitry may be included in the control box of an automatically actuated power transfer switch to further facilitate switching between the main power source and the standby power source. For example, interlock circuits may be provided to prevent the standby power source from starting unless standby power receptacle is connected to standby power source 20. Also, a microprocessor may be included to manage the sensing and activating switching functions of the interface circuit. Detection circuitry may be included which will disconnect the main power source in response to tone signals sent through power lines from the utility. Finally, a battery charger may be included.

Manual Power Transfer Switch (FIGS. 11-13)

FIG. 11 is an exploded perspective view of meter collar 10 that fits between and is connected to meter box 12 and watt-hour meter 14. Meter collar 10 houses a manual power transfer switch 56. Between the automatic power transfer switch discussed above and the manual power transfer switch, like structure is referred to by like numerals throughout the several views. Meter collar 10 includes housing 54 extending from sidewall 50 of switch housing 18. Housing 54 houses a receptacle 180 for connecting standby power source 20 to power transfer switch 56. Standby power source 20 includes a power cord and plug 182, which is used to connect standby power source 20 to power transfer switch 56.

In a manually actuated power transfer switch, when a power failure occurs, the facility occupant starts standby power source 20 and manually actuates the switch. A switch rod 184 is used to actuate the power transfer switch and switch the electrical load between the main power source and the standby power source. A port 186 formed in sidewall 50 of switch housing 18 facilitates manual switching of the power transfer switch. A switch lever 188 is attached to shaft 82 of rotor 86 and is located adjacent the front of cover plate 80. Switch lever 188 includes a bearing 190 sized to fit the upper end of shaft 82 such that rotor 86 is mechanically connected to switch lever 188. Switch rod 184 is inserted into port 186, which guides rod 184 into a socket 192 in switch lever 188. Switch lever 188 is rotated by switch rod 184 such that the rotor rotates and the rotor contact bars move between the main power contacts and the standby power contacts. When not in use, the port may be protected by a removable switch cover 194 to protect against contamination. Switch rod 184 is preferably removable from the port and may be stored in another location to prevent unauthorized switch operation.

A manual power transfer switch provides the facility occupant with an option of using standby power source 20, or not, during a power failure or at any other time as desired by the occupant. In addition, with the manual power transfer switch, standby power source 20 may be stored on site, permanently connected to the power transfer switch, or stored off site and used elsewhere. The electrical load of the facility is not switched to standby power source 20 unless desired and initiated by the facility occupant.

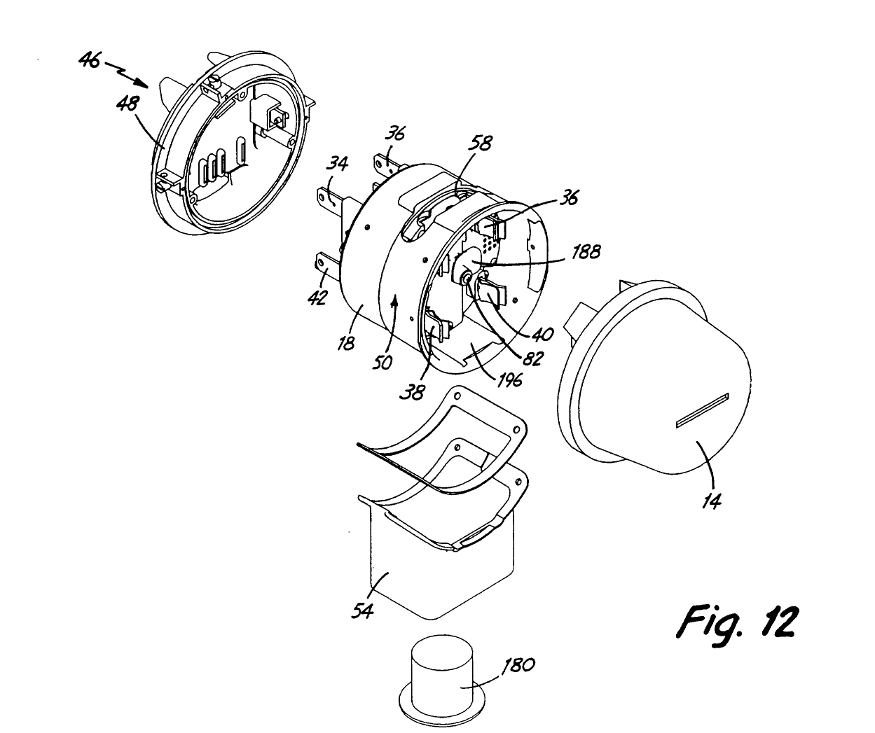

FIG. 12 is an exploded view of an embodiment of switch assembly 46 having a manually actuated power transfer switch 56. The manually actuated power transfer switch 56 includes housing 54 attached to sidewall 50 of switch housing 18. Housing 54 houses standby power receptacle 180 for connecting standby power source 20 to power transfer switch 56 via plug 182 (shown in FIG. 11). Standby power receptacle 180 acts as a conduit from power transfer switch 56 to standby power source 20. Plug 182 is inserted into receptacle 180 to connect standby power source 20 to power transfer switch 56. A port 196 is formed in sidewall 50 of switch housing 18 for standby power receptacle 180 to pass through and connect to power transfer switch 56.

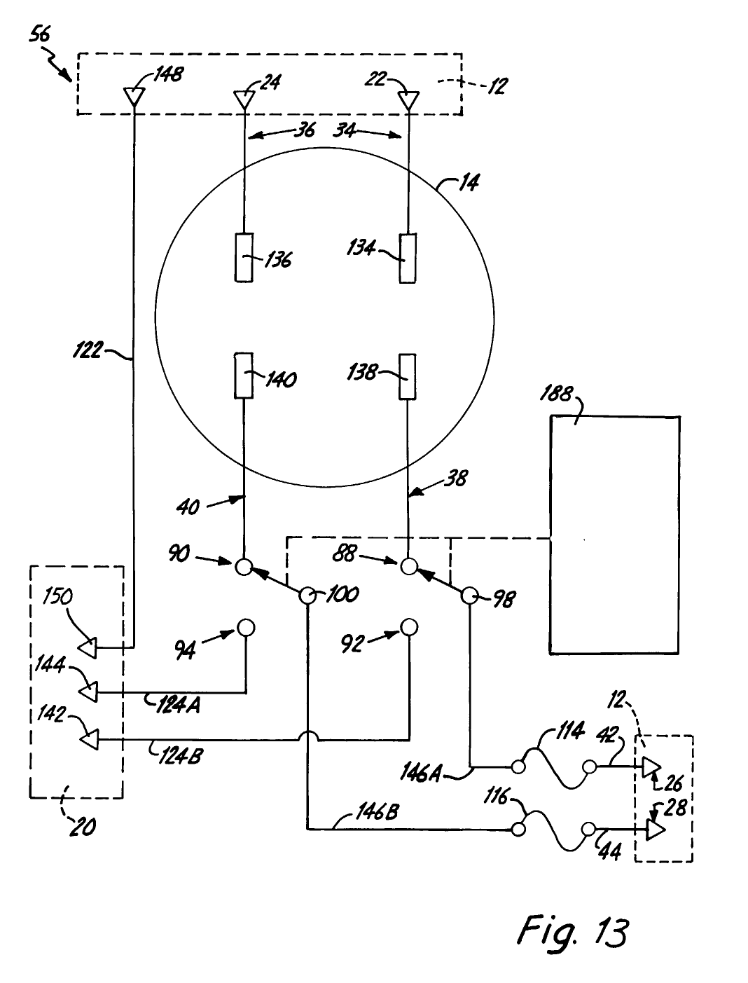

FIG. 13 is a schematic diagram of the manual power transfer switch 56. Manual power transfer switch 56 functions in the same manner as the automatic power transfer switch discussed above to transfer a facility's electrical load between the main power source and standby power source. However, the manual power transfer switch is actuated when activated by the facility occupant rather than an interface circuit.

Neutral wire 122 is also contained in meter collar 10. Neutral wire 122 passes directly through switch housing 18 from watt-hour meter neutral bus bar 148 in meter box 12 to input connector 150 in standby power source 20, but does not terminate in housing 18.

Switch lever 188, or manual actuator, is mechanically connected to rotor 86 via the upper end of shaft 82 (shown in FIG. 11). Switch rod 184 (shown in FIG. 11) is inserted into a socket of switch lever 188. Movement of the switch rod from side-to-side causes switch lever 188 to rotate rotor 86 and thereby move rotor contact bars 98, 100 from main power contact blocks 88, 90 to standby power contact blocks 92, 94, and vice versa. Upon a loss of power from the main power source or when desired by the facility occupant, switch lever 188 is moved to actuate and rotate rotor 86 and transfer the electrical load from one power source to another. Because power transfer switch 56 is manually actuated, the electrical load is transferred between the two power sources only when desired by the occupant and not automatically upon loss or restoration of power. This feature is beneficial when the facility is small, the consequences of a long term outage is not critical or power failure is a rare occurrence.

New Installations

The automatic and manual power transfer switches have been shown packaged in a meter collar which is connected between a meter box and a watt-hour meter. However, the power transfer switches may also be packaged in a single, self-contained electric meter box including the power transfer switch and watt-hour meter. A self-contained electric meter is ideally used as an original installation for a new building. An automatically actuation embodiment of the electric meter would further include a control mechanism for actuating the power transfer switch.

### CONCLUSION

The present invention is a power transfer switch for automatically or manually switching a power source for a facility's electrical load between a main power source and a standby power source. The power transfer switch is packaged in a switch housing which forms a meter collar, or switch assembly, that fits between the meter box and the watt-hour meter. The meter box has main power contacts which are connected to a main power source and customer-side or load contacts which are connected to at least one load. The meter collar includes a housing with first contacts for connection to the main power contacts of the meter box and second contacts for connection to the customer-side contacts of the meter box. The housing has further contacts for connection with the watt-hour meter and contacts for connection to the standby power source. The meter collar also includes a rotary switch within the housing. The rotary switch has a first position in which the main power contacts are connected to the customer-side contacts and a second position in which the standby power source is connected to the customer-side contacts.

The power transfer switch is preferably encased in one package, the meter collar assembled, shipped and sold as a single package. The meter collar is easy to install, which results in reduced time and expense for installation. In an existing facility, no electrical wiring changes to existing electrical power panels are required. The meter collar fits between and connects to a watt-hour meter and a meter box.

With a manually actuated switch, the facility occupant is allowed to determine when a power failure is critical and use of the standby-power source is desired. Only when the occupant switches the transfer switch from the main power source to the standby power source is the standby power source activated. The occupant determines when use of the standby power source is necessary and initiates such use. The standby power source may be stored or used at another location, rather than permanently on site, to be used only when the occupant desires. When the occupant wants to use the standby power source it may be moved onsite and plugged into the transfer switch via the receptacle.

In an embodiment of the present invention including an automatically actuated switch assembly, the facility's electrical load may be automatically switched from the main power source to the standby power source. An automatically actuated switch assembly is connected to a control box which senses when the main power source is on or off, activates the standby power source if necessary and actuates the power transfer switch to connect the facility's load to either the main power source or standby power source.

Although the present invention has been described with reference to preferred embodiments, workers skilled in the art will recognize that changes may be made in form and detail without departing from the spirit and scope of the invention. For example, if a standby power source is not plugged into the receptacle, the power transfer switch can be used alone as a shut-off switch for the main power source.

1. A power transfer switch for use between a watt-hour meter and a meter box, the meter box having main power contacts which are connected to a main power source and having customer-side contacts which are connected to at least one load, the power transfer switch comprising:
a base having first contacts for connection to the main power contacts of the meter box and second contacts for connection to the customer-side contacts of the meter box, the base additionally having further contacts for connection with the watt-hour meter and contacts for connection with a standby power source;
a rotary switch having a first position in which the main power contacts are connected to the customer-side contacts, and a second position in which the standby power source is connected to the customer-side contacts.

2. The power transfer switch of claim 1, and further comprising:
a pair of fuses connected between the rotary switch and the customer-side contacts.

3. The power transfer switch of claim 1 wherein the rotary switch comprises:
a stator supporting a first pair of stator contacts for receiving power from the main power contacts and a second pair of stator contacts for receiving power from the standby power source; and
a rotor supporting a pair of rotor contacts for connecting the first pair of stator contacts to the customer-side contacts when the rotor is in the first position and for connecting the second pair of stator contacts to the customer-side contacts when the rotor is in the second position.

4. The power transfer switch of claim 1 wherein the main power source is power lines of a utility.

5. The power transfer switch of claim 1, and further comprising: means for automatically actuating the rotary switch between the first position and the second position.

6. The power transfer switch of claim 5 wherein the means are a motor connected to the rotary switch.

7. The power transfer switch of claim 6, and further comprising:
a manual override switch connected to the rotor to manually actuate the rotary switch.

8. The power transfer switch of claim 1, and further comprising:
a port accessing the rotor to permit manual actuation of the rotary switch.

9. The power transfer switch of claim 8, and further comprising:
a rod insertable into the port wherein side to side movement of the rod causes manual actuation of the rotary switch.

10. The power transfer switch of claim 1, and further comprising:
a standby power receptacle coupled to the meter collar for receiving a plug that is connected to the standby power source.

11. A power transfer switch for use between a watt-hour meter and a meter box, the power transfer switch permitting switching between a main power source and a standby power source and the meter box including main power contacts connected to the main power source and load contacts connected to at least one load, the power transfer switch comprising:
a pair of main bus bars for connection to the main power contacts;
a pair of load bus bars for connection to the load contacts;
a pair of first stationary contacts connected to a pair of meter bus bars, the meter bus bars being connected to the watt-hour meter;
a pair of second stationary contacts connected to the standby power source;
a stator for supporting the stationary contacts;
a rotor rotatable with respect to the stator between a first position and a second position; and
a pair of rotor contacts supported by the rotor and connected to the load bus bars wherein when the rotor is in the first position the rotor contacts engage the first stationary contacts to provide a connection between the main power contacts and the load contacts, and when the rotor is in the second position the rotor contacts engage the second stationary contacts to provide a connection between the standby power source and the load contacts.

12. The power transfer switch of claim 11 wherein the power transfer switch is housed within a housing for connection between the watt-hour meter and the meter box.

13. The meter collar of claim 12, and further comprising:
a port in a side wall of the housing to permit manual actuation of the rotor.

14. The meter collar of claim 13, and further comprising:
a switch cover removably attached to the housing to cover the port.

15. The power transfer switch of claim 11, and further comprising a pair of fuses connected between the rotary contacts and the load bus bars.

16. The power transfer switch of claim 11, and further comprising:
A motor to actuate the rotor between the first position and the second position.

17. The power transfer switch of claim 11, and further comprising a pair of standby power conductors terminating at a first end at the stator and at a second end in a standby power receptacle, the standby power conductors connected between the second stationary contacts and the standby power receptacle.

18. The power transfer switch of claim 17 wherein the standby power receptacle receives a plug that is connected to the standby power source.

19. The power transfer switch of claim 11, and further comprising:
a switch lever connected to the rotor wherein movement of the lever rotates the rotor between the first position and the second position.

20. The power transfer switch of claim 19, and further comprising:
a rod which is insertable into a socket of the switch lever wherein side to side movement of the rod causes the switch lever to rotate the rotor between the first position and the second position.

21. A power transfer switch for switching between a main power source and a standby power source, the power transfer switch comprising:
standby power conductors terminating at a first end and at a second end at the standby power source;
a pair of main power bus bars for connection to main power contacts;
a pair of load bus bars for connection to load contacts;
a pair of main power terminals for connection to a watt-hour meter, the main power terminals being connected to the main power bus bars;
a pair of meter bus bars for connection to the watt-hour meter;
a pair of fuses connected to the pair of load bus bars;
a first pair of stationary contacts connected to the meter bus bars;
a second pair of stationary contacts connected to the standby power conductors;
a stator for supporting the first and second pair of stationary contacts;
a rotor rotatable with respect to the stator between a first position and a second position; and
a pair of rotor contacts supported by the rotor and connected to the pair of fuses so that when the rotor is in the first position, the rotor contacts engage the first pair of stationary contacts to provide a connection path for the main power contacts to the load contacts, and when the rotor is in the second position, the rotor contacts engage the second pair of stationary contacts to provide a connection path from the standby power source to the load contacts.

22. The power transfer switch of claim 21 wherein the power transfer switch is housed in a housing.

23. The power transfer switch of claim 21 and further comprising: a motor connected to the rotor for automatically rotating the rotor.

24. The power transfer switch of claim 21, and further comprising:
a lever socket connected to the rotor wherein movement of the lever rotates the rotor between the first position and the second position.

25. The power transfer switch of claim 24, and further comprising:
a rod insertable into the lever socket wherein side to side movement of the rod causes the lever socket to rotate the rotor between the first position and the second position.

26. The power transfer switch of claim 21, and further comprising:
a standby power receptacle connected to the standby power conductors wherein a plug connected to the standby power source is inserted into the standby power receptacle to connect the standby power source to the power transfer switch.

27. A method for switching at least one load between a main power source and a standby power source wherein the main power source has main power contacts and the load has customer-side contacts, the method comprising:
connecting a power transfer switch between a watt-hour meter and a meter box, the power transfer switch having main power bus bars for connection with the main power contacts in the meter box, having load bus bars for connection with the customer-side contacts in the meter box, and being coupled to the standby power source; and
actuating a rotor in the power transfer switch between a first position and a second position wherein when the rotor is in the first position the main power contacts are connected to the customer-side contacts and when the rotor switch is in the second position the standby power source is connected to the customer-side contacts.

28. The method of claim 27 wherein actuating the rotor comprises automatically switching the rotor based upon signals from an interface circuit.

29. The method of claim 28 wherein a motor actuates the rotor.

30. The method of claim 27 wherein actuating the rotor comprises manually switching the rotor.

31. The method of claim 30, and further comprising:
inserting a rod into the rotor; and
moving the rod from side to side to switch the rotor between the first position and the second position.
